(19) United States
(12) Patent Application Publication
(10) Pub. No.: US 2017/0311568 A1
(43) Pub. Date: Nov. 2, 2017

(54) VIBRATORY PET TOY WITH REPLACEABLE COVER

(71) Applicant: WORLDWISE, INC., Novato, CA (US)

(72) Inventors: Charles Floyd, Oakland, CA (US); Karen Heathwood, San Rafael, CA (US); Victoria Davila, San Francisco, CA (US)

(21) Appl. No.: 15/139,708

(22) Filed: Apr. 27, 2016

(51) Int. Cl. A01K 15/02

(52) U.S. Cl. CPC A01K 15/026

(57) ABSTRACT

A vibratory pet toy having a pod, the pod being characterized as having an outer shell and housed within it is a rotational motor and eccentric load rotatable by the rotational motor and a power supply for selectively activating the rotational motor. A flexible cover having a top and bottom forms an interior volume and an opening between the top and bottom for gaining access to the interior volume, the pod being sized to selectively pass through the opening to be frictionally secured between the top and bottom and within the interior volume.

### TECHNICAL FIELD

The present invention is directed to a pet toy specifically intended to be of interest to domestic cats. The toy vibrates and emits a buzzing sound by providing a pod housing the source of the vibration and buzzing sound which can be inserted within relatively soft and flexible covers to renew a cat's interest and to prevent the cat from degrading the pod.

### BACKGROUND OF THE INVENTION

It is well known that pets, and particularly cats, have certain instinctual needs which must be satisfied. Failure to do so can not only recall in the expression of overt antisocial behavior but can even adversely affect the health and well-being of the animal. One of these needs is to hunt by swiping and pouncing upon an object which stimulates the cat's curiosity.

A cat's instinct to swipe and pounce upon an attractant is well known to virtually any cat owner. It is quite common to see a pet owner dangle an attractant such as a feathered bundle or plush mouse in a cat's vicinity to appreciate this instinctual behavior. Such toys also help keep cats occupied and exercised while providing the pet's owner with the enjoyment of watching his or her cat at play.

Although there are a plethora of cat toys which have been designed to satisfy the cat's need to hunt, most are either overly complex, fail to achieve their intended objective or are subject to breakage. Usually one such a toy is in the slightest way damaged, the entire toy must be discarded. Furthermore, most toys, upon purchase, have a set configuration as to color, size and orientation and, as such, often times, a cat will lose interest regardless of the toys initial stimulation.

There are a significant number of vibratory toys such as those disclosed in U.S. Pat. Nos. 8,038,503, 8,591,281, 8,834,226, 8,834,227, 8,882,558, 8,905,813, 9,017,136 and 9,050,541, all of which are related as having a common assignee. The vibratory powered toys of the prior art, as exemplified by the cited patents, use rotational motors that spin a shaft attached to a counterweight. The rotation of the counterweight induces an oscillatory motion, which, in turn, causes the toy to vibrate and bounce along a support surface. Such toys are taught to have elongated bodies and “legs” arranged in rows on each side of their bodies, the legs being curved and off-set causing the toy to move in a linear path. Although such toys are capable of amusing a cat, their linear motion has been found to be less than ideal in satisfying the cats need to hunt and pounce. In addition, a stimulating cat is notorious in its quest to hunt, pounce and to degrade any toy which grabs its attention. If the “legs” of such a toy are deformed or detached from its body, the toy's characteristic movement will be lost.

It has now been found that a superior vibratory toy in the form of a reusable pod insertable within a flexible rubber or rubberlike cover is highly stimulating, resistant to degradation through abusive play and capable of renewing the cat's interest by replacing covers of differing animal shapes and colors. Thus, the attributes of a vibratory toy can be realized while overcoming the limitations of the prior art.

These further objects will be more readily apparent when considering the following disclosure and appended claims.

### SUMMARY OF THE INVENTION

A vibratory pet toy comprising:
a pod, said pod comprising an outer shell and housed therein a rotational motor and eccentric load rotatable by said rotational motor and a power supply for selectively activating said rotational motor;
a flexible cover having a top and bottom forming an interior volume and an opening between said top and bottom for gaining access to said interior volume;
said pod being sized to selectively pass through said opening and be frictionally secured between said top and bottom and within said interior volume.

A kit comprising:
a pod, said pod comprising an outer shell and having therein a rotational motor and eccentric load rotatable by said rotational motor and a power supply for selectively activating said rotational motor;
a plurality of flexible covers, each flexible cover having a top and bottom forming an interior volume and an opening between said top and bottom for gaining access to said interior volume, said pod being sized to selectively pass through said opening in each of said plurality of flexible covers and to be frictionally received between said top and bottom and within said interior volume of each of said plurality of flexible covers.

### BRIEF DESCRIPTION OF THE FIGURES

FIG. 1 is a side view of a pod used as a component of the present invention showing its internal parts.

FIG. 2 is a front view of a flexible cover as a component of the present invention.

FIG. 3 is a front view of the present invention showing the pod of FIG. 1 positioned within the flexible cover of FIG. 2.

FIG. 4 is a perspective view of the present.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

The present invention is directed to a vibratory pet toy as well as a kit based upon it. The first component of the vibratory pet toy is depicted in FIG. 1. Pod 10 is comprised of outer shell 12 preferably of plastic which resists degradation by engagement of a pet. Outer shelf 12 forms an oval surface devoid of acute or obtuse corners as depleted in FIG. 1.

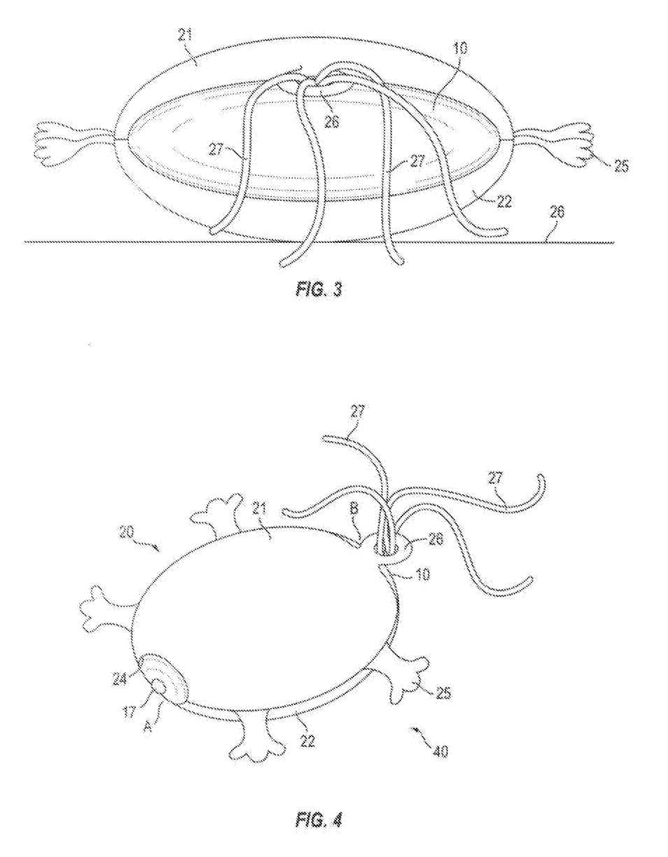

As noted, the present toy operates by vibration causing the toy to vibrate and to create a buzzing sound as the toy bounces about a supporting surface such as surface 26 (FIG. 3) which stimulates a cat's hunting and pouncing instincts. This is generally accomplished by providing rotational motor 15 positioned within outer shell 12 joined to an eccentric load 16 rotated by rotational motor 15. Motor 15 can be powered by a suitable power supply 11, generally in the form of batteries. When batteries are employed, they can be accessed via a closable latch (not shown) used to introduce fresh batteries as needed. Motor 15 can also be selectively activated by switch 13 controllable by user-activated toggle 14. Pod 10 is completed by providing light source 17 which generally activates simultaneously with the activation of motor 15. Light source 17 can be an LED, incandescent bulb or similar expedient.

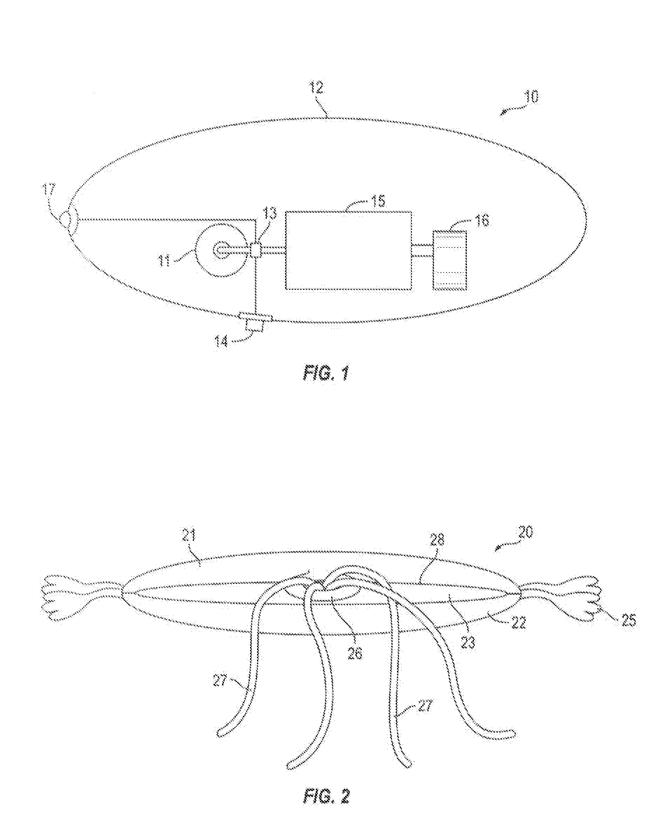

Flexible cover 20 is shown in FIG. 2 in a relaxed state prior to acceptance of pod 10 therein. Flexible cover 20 is characterized as having a top 21 and bottom 22 forming an interior volume 23 and an opening 28 between top 21 and bottom 22 for gaining access to the interior volume 23. Ideally, flexible cover 20 comprises rubber or similar material which is stretchable.

In constructing the vibratory pet toy 40 of FIG. 4, pod 10 is introduced to interior volume 23 by stretching the flexible cover over pod 10 until pod 10 is seated within interior volume 23 as depicted in FIG. 3. Pod 10 and cover 20 are sized to ensure a snug fit of pod 10 within interior volume 23. As, ideally, flexible cover 20 is generally in the shape of an animal having appendages shown as “legs” extending therefrom, one's pet cat would generally be intrigued and stimulated in seeing an animal-shaped toy having a relatively soft and flexible cover vibrating, buzzing and randomly bouncing upon support surface 26.

In turning to FIG. 4, it is noted that flexible cover 20 is characterized as having a head region “B” and a tail region “A”. Interest is further stimulated by providing loop 26 in tail region “A” to which an attractant such as tale 27 is appended. At head region “B”, cut out portion 24 is provided so that light source 17 is visible there through. As such, during operation, not only does vibratory pet toy 40 buzz, vibrate and erratically move upon a support surface, but light source 17 illuminates, tall 27 shakes and “legs” 25 vibrate enhancing the stimulating effect of the present toy.

As noted previously, the present invention can also be characterized as being in the form of a kit. Specifically, pod 10 can be employed repeatedly with different flexible covers 20 while remaining within the spirit and scope of the present invention. It is believed that a cat activity engaging vibratory to 40 will, in time, degrade cover 20 to the point where it no longer serves the purpose of supporting and frictionally housing pod 10 as intended. Rather than to replace the entire vibratory toy, flexible cover 20 can be replaced with another flexible cover creating what is virtually a new toy as needed. Even if flexible cover 20 was not sufficiently degraded to as to require replacement, the present vibratory toy could be sold with multiple flexible covers of different shapes and colors to create renewed interest.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A vibratory pet toy comprising:
a pod, said pod comprising an outer shell and housed therein a rotational motor and eccentric load rotatable by said rotational motor and a power supply for selectively activating said rotational motor;
a flexible cover having a top and bottom forming an interior volume and an opening between said top and bottom for gaining access to said interior volume;
said pod being sized to selectively pass through said opening and be frictionally secured between said top and bottom and within said interior volume.

2. The vibratory pet toy of claim 1 wherein said outer shell comprises plastic which resists degradation by engagement of a pet.

3. The vibratory pet toy of claim 1 wherein said outer shell comprises and oval surface.

4. The vibratory pet toy of claim 3 wherein said oval surface is devoid of any acute or obtuse corners.

5. The vibratory pet toy of claim 1 wherein said flexible cover comprises rubber.

6. The vibratory pet toy of claim 1 wherein said flexible cover comprises a stretchable material and wherein said internal volume if sized to deform upon the insertion of said pod therein to be frictionally retain said pod within said flexible cover.

7. The vibratory pet toy of claim 1 wherein said flexible cover comprises a shape of an animal.

8. The vibratory pet toy of claim 7 wherein said flexible cover comprises legs extending from said top or bottom.

9. The vibratory pet toy of claim 1 wherein said flexible cover is further defined as comprising a head region and a tail region, said opening between said top and bottom for gaining access to said interior volume being located at said tail region, said flexible cover further providing a cut out portion located at said head region.

10. The vibratory pet toy of claim 9 wherein said pod further comprises a light source positioned such that when said pod is frictionally secured between said top and bottom and within said interior volume, said light source is visible through said cutout portion.

11. The vibratory pet toy of claim 9 wherein said flexible cover further comprises a tail located at said tail region.

12. A kit comprising:
a pod, said pod comprising an outer shell and having therein a rotational motor and eccentric load rotatable by said rotational motor and a power supply for selectively activating said rotational motor;
a plurality of flexible covers, each flexible cover having a top and bottom forming an interior volume and an opening between said top and bottom for gaining access to said interior volume, said pod being sized to selectively pass through said opening in each of said plurality of flexible covers and to be frictionally received between said top and bottom and within said interior volume of each of said plurality of flexible covers.

13. The kit of claim 12 wherein said outer shell comprises plastic which resists degradation by engagement of a pet.

14. The kit of claim 12 wherein said outer shell comprises and oval surface.

15. The kit of claim 14 wherein said outer surface is devoid of any acute or obtuse corners.

16. The kit of claim 12 wherein said flexible covers each comprises rubber.

17. The kit of claim 12 wherein said covers each comprise a stretchable material wherein said internal volume of each is sized to deform upon the insertion of said pod through said opening to frictionally retain said pod with in the interior volume of each flexible cover.

18. The kit of claim 12 wherein said flexible covers are further defined as comprising a head region and a tail region, said opening between said top and bottom for gaining access so said interior volume being located at said tail regime, said flexible covers further providing a cut out portions located at said head region.

19. The kit of claim 18 wherein said pod further comprises a light source positioned such that when said pod is frictionally secured between said top and bottom and within said interior volume, said light source is visible through said cutout portion.

20. The kit of claim 18 wherein said flexible covers further comprise a tail located at said tail region.
